(19) United States
(12) Patent Application Publication
(10) Pub. No.: US 2026/0242179 A1
(43) Pub. Date: Aug. 20, 2026

(54) Shaft Module and Method for Producing an Elevator Shaft Composed of Shaft Modules Mounted One on Top of the Other

(71) Applicant: INVENTIO AG, Hergiswil (CH)

(72) Inventors: Raphael Bitzi, Luzern (CH); Bjarne Lindberg, Hellbühl (CH)

(21) Appl. No.: 19/489,560

(22) PCT Filed: Jul. 26, 2024
(86) PCT No.: PCT/EP2024/071292

§ 371 Date: Dec. 2, 2025

(30) Foreign Application Priority Data
Aug. 7, 2023 (EP) 23189910.5

(51) Int. Cl. B66B 11/00; B66B 19/00

(52) U.S. Cl. CPC B66B 11/0005; B66B 19/00

(57) ABSTRACT

A shaft module and a method for producing an elevator shaft; composed of vertically mounted shaft modules. The shaft module has a first and second side wall. A guide rail piece is fixed at least indirectly to one of the side walls. The shaft module can assume an installed state and an operating state. It has a lower and an upper support device and the lower support device is immovably connected to a lower end of the first side wall and a lower end of the second side wall. The upper support device rests on the lower support device. Said guide rail piece rests, on the upper and the lower support devices. In the installed state, the upper support device is arranged to be displaceable relative to the lower support device, and, in the operating state, the upper support device is arranged immovably relative to the lower support device.

### CROSS-REFERENCE TO RELATED APPLICATIONS

This application is a national phase entry under 35 U.S.C. § 371 of the international patent application PCT/EP2024/071292 filed on Jul. 26, 2024 and published under the publication number WO 2025/031835A1, claiming priority right from the European patent application EP 23189910.5 filed on Aug. 7, 2023.

### FIELD OF THE INVENTION

The invention relates to a shaft module for forming a lowermost shaft module of an elevator shaft composed of shaft modules mounted one on top of the other, and to a method for producing the same.

### BACKGROUND OF THE INVENTION

The installation of an elevator system is complex and therefore involves considerable costs. In particular, the creation of an elevator shaft for an elevator system, e.g., when constructing a building, and the subsequent installation of elevator components in the elevator shaft is quite complex. Usually, the elevator shaft is first created completely, inside the building receiving the elevator system, and the elevator system with its elevator components such as the car, counterweight, drive machine, and guide rails is subsequently installed in the elevator shaft. It has already been proposed to create the elevator shaft from a plurality of prefabricated shaft modules with shaft walls in which elevator components, such as guide rail pieces, are at least in some cases already pre-installed. Prefabrication and pre-installation in this case do not take place at the construction site of the building accommodating the elevator, i.e., at the elevator system installation site, but in a factory and thus at a manufacturing site. This procedure requires less time at the installation site. In addition, this procedure has positive effects on the quality of the installation and on the working safety of the installation personnel. A prefabricated shaft module encloses a cavity in the form of a shaft space, which can at least partially accommodate a car.

WO 2022/103795 A1 describes a shaft module for forming a lowermost shaft module of an elevator shaft, composed of shaft modules mounted one on top of the other, for an elevator system in the form of a so-called pit module. The pit module has two opposite side walls to which guide rail pieces can be fixed at least indirectly. WO 2022/103795 A1 also describes a method for producing an elevator shaft composed of shaft modules mounted one on top of the other.

EP 3960677 A1 also describes a shaft module for forming a lowermost shaft module of an elevator shaft composed of shaft modules mounted one on top of the other. Guide rail pieces fixed to opposite side walls are supported on a floor of the elevator shaft by two plates arranged one above the other and fixed relative to one another.

US 2004/129505 A1 describes a support device for supporting guide rails of an elevator system on a floor of a conventional elevator shaft, i.e., one that is not composed of individual shaft modules.

In contrast, the object of the invention is, in particular, to propose a shaft module and a method which enable both a secure installation of a guide rail piece in the shaft module at the manufacturing site, and an alignment of the pre-installed guide rail piece during installation of the elevator system. According to the invention, this object is achieved by a shaft module having the features of claim 1 and by a method having the features of claim 6.

The embodiments and exemplary embodiments of the invention described below relate equally to the shaft module and to the method. In other words, features mentioned below with reference, for example, to the shaft module can also be implemented as method steps, and vice versa.

### SUMMARY OF THE INVENTION

According to a first aspect of the invention, a shaft module for forming a lowermost shaft module of an elevator shaft, composed of shaft modules mounted one on top of the other is provided. The shaft module comprises: a first side wall; a second side wall opposite the first side wall; a guide rail piece fixed at least indirectly to one of the side walls; a lower support device, and an upper support device, wherein the upper support device rests on the lower support device from above, the guide rail piece rests on the upper support device and the lower support device from above, the lower support device is immovably connected to a lower end of the first side wall and a lower end of the second side wall and thus extends between the lower end of the first side wall and the lower end of the second side wall, the shaft module is configured to assume an installed state and an operating state, in the operating state of the shaft module, the upper support device is arranged immovably relative to the lower support device, and in the installed state of the shaft module, the upper support device is arranged so as to be displaceable relative to the lower support device.

According to a second aspect of the invention, a method for producing an elevator shaft composed of shaft modules mounted one on top of the other is provided, comprising: providing a shaft module according to the first aspect of the invention, arranging said shaft module on a shaft floor, aligning the upper support device, and fixing the upper support device and the lower support device to the shaft floor.

### DETAILED DESCRIPTION OF THE INVENTION

The shaft module for forming a lowermost shaft module of an elevator shaft, composed of shaft modules mounted one on top of the other, for an elevator system has a first side wall and a second side wall opposite the first side wall. A guide rail piece is fixed to one of the side walls at least indirectly; in particular, several guide rail pieces are fixed to both side walls. The lowermost shaft module of an elevator shaft composed of shaft modules mounted one on top of the other is referred to below as a pit module. According to the invention, the top module can assume an installed state and an operating state. It has a lower support device and an upper support device, wherein the lower support device is immovably connected to a lower end of the first side wall and a lower end of the second side wall and thus extends between the lower end of the first side wall and the lower end of the second side wall. The upper support device rests on top of the lower support device. Said guide rail piece rests, from above, on the upper support device and the lower support device. In the installed state of the shaft module, the upper support device is arranged so as to be displaceable relative to the lower support device, and, in the operating state of the shaft module, the upper support device is arranged immovably relative to the lower support device.

The provision of the upper and lower support devices on which the guide rail piece rests from above enables the guide rail piece to be securely fixed in the shaft module even if the shaft module is not placed on a floor. The guide rail piece can then be securely supported on the combination of upper and lower support devices and is fixed in the pit module such that it cannot detach from the pit module even during transport from the manufacturing site to the installation site. This allows the guide rail piece to be safely installed in the shaft module and transported in the shaft module from the manufacturing site of the shaft module to the installation site of the elevator system. During the mentioned transport, the pit module is in a transport state. In addition, the ability of the upper support device to move relative to the lower support device when the shaft module is in the installed state allows the upper support device and thus also the guide rail piece to be aligned during installation, thus enabling precise installation of the elevator system comprising the elevator shaft.

In the following, directional information such as above, below, and lateral or vertical and horizontal refers to the orientation of the respective component during an operating state of the elevator system. In this case, the operating state of the elevator system is understood to be the state following completion of the installation and commissioning of the elevator system. In the operating state of the elevator system, people and/or goods can thus be transported in the car between floors of the building in which the elevator system is located. When the elevator system is in the operating state, the shaft module in the form of the pit module is also in its operating state.

In addition to the two side walls, the pit module also has a front wall and a rear wall. The front wall and/or the rear wall can have a shaft opening in which a shaft door is or can be arranged. The side walls or all walls can be made of concrete or wood, or be formed by metal profiles.

When installing the elevator system, at least one, usually more than one, further shaft module is mounted on the pit module. These additional shaft modules, which are in particular identical in design, are referred to here as base modules. The elevator shaft is closed at the top, in particular, by what is known as a top module, which can include a drive for the elevator system.

In particular, more than one guide rail piece is arranged in the pit module-specifically, four guide rail pieces. Two guide rail pieces are used to guide a car of the elevator system, and two guide rail pieces are used to guide a counterweight connected to the car via a support means. In case of self-driven cars, the pit module can also have only two guide rail pieces for guiding the car. During installation of the elevator system, i.e., when the shaft modules are mounted one on top of the other or after they have been mounted one on top of the other, to form an elevator shaft, the guide rail pieces that belong together are joined together to form a continuous guide rail. The guide rail pieces are usually fixed to side walls of the pit module using so-called rail brackets or other special holders. This is understood here as an indirect fixation to a side wall.

The pit module can additionally have one or more buffers, which also rest, from above, on the upper support device and thus also on the lower support device. The buffers are arranged so that, when the elevator system is in the operating state, they are arranged below the car or below a counterweight.

The pit module can also contain further elevator components; this means that further elevator components can at least be pre-installed in the pit module at the manufacturing site. The elevator components can, for example, be a pulley of a speed regulator, a ladder, in particular for later maintenance of the elevator system, switches, in particular safety switches, and cabling-for example, for the switches mentioned.

The pit module can assume an installed state and an operating state. During installation of the elevator system, in particular during alignment of the upper support device, the pit module assumes its installed state. In the installed state, the upper support device can be displaced relative to the lower support device, which is immovable relative to the side walls. This ability to be displaced enables the aforementioned alignment of the upper support device during installation of the elevator system. The upper support device is aligned in particular such that the elevator system can be installed with existing adjustment options on shaft doors and rail brackets. After the installation of the elevator system is completed, the elevator system and thus also the upper support device are in their respective operating state. In this state, the car is moved in a vertical direction along the guide rails resting on the upper support device. The aforementioned immovable arrangement of the upper support device relative to the lower support device in the operating state of the upper support device ensures that an alignment of the upper support device and the guide rails carried out during installation is maintained during operation of the elevator system.

The lower support device is, for example, screwed, welded, or riveted to the lower ends of the first and second side walls for the aforementioned immovable connection. It can also be made in one piece with a side wall or be part of the side wall. It thus forms in all operating states of the pit module a stable abutment, on which the upper support device and the guide rail piece can rest.

The upper and/or lower support elements are made in particular of metal and have in particular a T-shaped basic shape, wherein a transverse element runs along a side wall. At least the upper support element can be referred to as a pit set and can basically be constructed like an “elevator pit assembly,” as described in U.S. Pat. No. 7,000,736 B2. Such pit sets are available on the market.

The upper and/or lower support elements may consist of metal plates. However, it is also possible for at least one of the two support elements to have profiles arranged next to one another and spaced apart from one another, in particular metal profiles, which are connected to one another by cross connectors. The profiles mentioned are designed in particular as corner profiles. A support element constructed in this way requires little weight and is lightweight. Such pit sets are also available on the market.

In one embodiment of the invention, the upper support device has an upper recess, and the lower support device has a corresponding lower recess. The recesses mentioned are designed and arranged so as to overlap at least partially both in the installed state and in the operating state of the shaft module. This allows, on the one hand, easy fixation of the upper and lower support devices to a shaft floor and, on the other, alignment of the upper support device. The aforementioned recesses are intended to allow a fastener, e.g., in the form of a screw or anchor bolt, to be guided through an upper and a corresponding lower recess, thus enabling the upper and lower support devices to be fixed to the shaft floor. The fastener can already be guided through the recesses while the pit module is in the installed state and can be pre-fixed at least to the shaft floor. It is therefore at least pre-fixed to the shaft floor already during alignment of the upper support device. The aforementioned embodiment of the recesses then still allows alignment of the upper support element.

The two support devices have, in particular, several corresponding recesses. The recesses are designed in particular as through-holes with a circular diameter, wherein a diameter of an upper through-hole of the upper support device is smaller than the diameter of a lower through-hole of the lower support device.

In one embodiment of the invention, in a transport state of the shaft module, the upper support device and the lower support device are immovably but detachably connected to one another. This enables particularly safe transport of the pit module from the manufacturing site to the installation site.

The pit module is brought into its transport state at the manufacturing site, i.e., in the aforementioned embodiment, the upper support device and the lower support device are immovably but detachably connected to one another. After the pit module has been transported to the installation site, the aforementioned connection between the two support devices is released, thus bringing the pit module from the transport state into the installed state. This can be done before or after the pit module has been placed in its final position.

The aforementioned detachable connection between the upper support device and the lower support device is in particular designed and arranged such that it can be released from above. This makes it particularly easy to release the connection.

By means of the aforementioned detachable connection between the upper support device and the lower support device, in particular a guide rail piece and/or a buffer is fixed at least indirectly to the upper support device. This advantageously allows the aforementioned guide rail piece and/or the aforementioned buffer to be safely transported with the pit module and made available for installation at the correct location.

The detachable connection can be made, for example, by means of self-tapping screws or by means of clamping sleeves inserted into corresponding recesses in the upper and lower support devices. The aforementioned clamping sleeves can be knocked out or drilled out to release the connection.

The aforementioned object is also achieved by a method for producing an elevator shaft composed of shaft modules mounted one on top of the other, comprising the method steps of
providing a shaft module as described above in the form of a pit module,
arranging the aforementioned shaft module on a shaft floor,
aligning the upper support device, and
fixing the upper support device and the lower support device to the shaft floor.

Providing a shaft module is to be understood here to mean that the shaft module is manufactured at the manufacturing site and transported to the installation site. Arranging the shaft module on a shaft floor is to be understood here to mean that the shaft module is placed or set down on the shaft floor. This is done in particular by means of a crane. After being arranged on the shaft floor, the entire shaft module can be aligned, in particular by placing leveling plates underneath-for example, to compensate for un-evenness of the shaft floor or to ensure vertical alignment of the side walls.

Before the mentioned alignment of the upper support device, a possibly existing detachable connection between the upper and the lower support devices is released as described above. Alignment of the upper support device is thus carried out when the shaft module is in the installed state. During alignment, the upper support device is moved relative to the lower support device. Fixing the upper support device and the lower support device to the shaft floor is carried out, in particular, as described above in connection with the corresponding recesses in the upper and lower support devices. In particular, alignment of the upper support device takes place only once all shaft modules have been mounted one on top of the other to form an elevator shaft.

In one embodiment of the invention, the lower support device is mortared in place relative to the shaft floor. This enables particularly secure support of the guide rail pieces and thus of the guide rails via the upper support device and the lower support device on the shaft floor. The secure support ensures that the guide rails remain correctly aligned during operation of the elevator system, thus enabling safe and comfortable operation of the elevator system. Mortaring is carried out in particular before the upper support device is aligned. Mortaring the lower support device relative to the shaft floor means filling a cavity that is created between the shaft floor and the lower support element when the pit module is placed on the shaft floor.

This ensures a stable, full-surface, and cavity-free placement of the lower support element on the shaft floor. Concrete or, in particular, special expanding mortar can be used for mortaring. The mortar can be applied by hand or with the help of a special mortar pump.

In particular, to fix the upper support device and the lower support device to the shaft floor, a fastener is guided through the upper recess of the upper support device and the corresponding lower recess of the lower support device and fastened in the shaft floor. This allows for particularly simple and stable fastening.

In particular, several fasteners are used, in particular in the form of screws or anchor bolts. In particular, a guide rail piece and/or a buffer are fixed at least indirectly to the shaft floor using one or more fasteners.

### BRIEF DESCRIPTION OF THE DRAWINGS

Further advantages, features, and details of the invention can be found in the following description of exemplary embodiments and with reference to the drawings, in which like or functionally like elements are provided with identical reference signs. The drawings are merely schematic and are not to scale.

In the drawings:

FIG. 1 shows an elevator system with a car in an elevator shaft composed of elevator shaft modules;

FIG. 2 shows a snapshot during placement of a base module on a pit module of an as yet unfinished elevator shaft of an elevator system;

FIG. 3 shows a side view of a pit module;

FIG. 4 shows an enlarged view from above of an upper support device and a lower support device of the pit module of FIG. 3; and

FIG. 5 shows a block diagram of a method for producing an elevator shaft composed of shaft modules mounted one on top of the other.

### DETAILED DESCRIPTION OF THE DRAWINGS

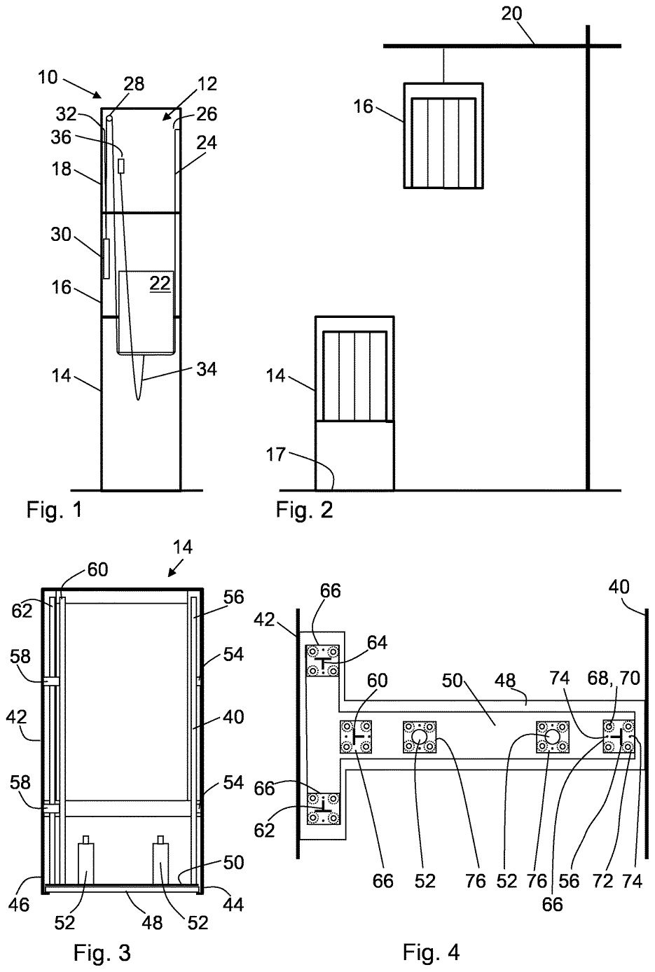

According to FIG. 1, an elevator system 10 has an elevator shaft 12 for a three-story building, which elevator shaft in the present exemplary embodiment is composed of a first pit module 14, a base module 16, and a top module 18. The elevator shaft 12 can comprise further second base modules 16, depending upon the number of floors. Said shaft modules 14, 16, 18 are pre-produced in a factory and therefore at a manufacturing site, and provided with elevator components. They are then transported to the construction site of the building receiving the elevator system 10, and thus to an installation site where they are mounted one on top of the other.

FIG. 2 shows how the base module 16 is placed on the pit module 14 from above using a crane 20. The pit module 14 was previously placed on a shaft floor 17 in the same way and thus arranged on the shaft floor 17. The top module 18 is then placed on the base module 16 in the same way, thus closing the elevator shaft 12 at the top.

The elevator system 10 in FIG. 1 moreover has a car 22 which can be moved vertically in the elevator shaft 12 along guide rails (not shown in FIG. 1). For this purpose, the elevator system 10 has a support means 24, the first end 26 of which is fixed in the top module 18. It then extends downwards and around the car 22 and is guided via a drive machine 28 arranged in the top module 18 opposite the first end 26 of the support means 24. From there, it runs through a suspension of a counterweight 30 to its second end 32, which is fixed in the region of the drive machine 28. The drive machine 28 can move the support means 24 and thus the car 22 in the elevator shaft 12. The car 22 is connected via a suspension cable 34 to an elevator controller 36 arranged in the top module 18. The suspension cable 34 makes possible a power supply to and a communication with the car 22.

According to FIG. 3 and FIG. 4, the pit module 14 has a vertically extending first side wall 40 and an opposite second side wall 42. The side walls 40, 42 are constructed from metal profiles like a front wall and a rear wall of the pit module 14. A lower support device 48 runs between a lower end 44 of the first side wall 40 and a lower end 46 of the second side wall 42. The lower support device 48 is screwed to the first side wall 40 and the second side wall 42 by means of screw connections (not shown) and is thus immovably connected to the lower end 44 of the first side wall 40 and the lower end 46 of the second side wall 42. In addition to the screw connection mentioned above, other connection techniques such as welding or riveting are also possible.

An upper support device 50 rests, from above, on the lower support device 48, so that the upper support device 50 is supported, from above, on the lower support device 48. Two buffers 52 are arranged on the upper support device 50, which are arranged below the car 22 in the operating state of the elevator system 10.

A first guide rail piece 56 is fixed to the first side wall 40 via rail brackets 54. A second guide rail piece 60 is fixed to the second side wall 42 via two omega brackets 58. The first guide rail piece 56 and the second guide rail piece 60 stand on the upper support device 50 and are thus supported from above via the upper support device 50 on the lower support device 48. In the operating state of the elevator system 10, the first and the second guide rail pieces 56, 60 are part of continuous guide rails on which the car 22 is guided.

The omega brackets 58 are designed such that the second guide rail piece 60 is spaced apart from the second side wall 42. A travel path of the counterweight 30 runs in the resulting space when the elevator system 10 is in the operating state. A third guide rail piece 62 is fixed to the omega brackets 58, and a fourth guide rail piece 64 is fixed to the second side wall 42 to guide the counterweight 30. The third guide rail piece 62 and the fourth guide rail piece 64 also stand on the upper support device 50 and are thus supported from above via the upper support device 50 on the lower support device 48.

As can be seen in FIG. 4, both the upper support device 50 and the lower support device 48 have a mainly T-shaped basic shape. The lower support device 48 projects beyond the upper support device 50 in all horizontal directions. The guide rail pieces 56, 60, 62, and 64 rest, from above, on the upper support device 50 via rail supports 66, not shown in FIG. 3.

The rail supports 66 are basically constructed in the same way, which is why only one rail support 66 is described in more detail. The rail support 66 is designed as a mainly rectangular metal plate and has a round through-hole 68 at each of its corners. The through-holes 68 of the rail support 66 coincide with through-holes 70 of the upper support device 50. The lower support device 48 has through-holes 72 with a larger diameter that correspond to the through-holes 70 of the upper support device 50. Corresponding through-holes 70 and 72 overlap one another. Corresponding through-holes 70 and 72 are designed and arranged so as to overlap at least partially even after a displacement of the upper support device 50 relative to the lower support device 48. The through-holes 70 of the upper support device 50 can be referred to as upper recesses of the upper support device 50, and the through-holes 72 of the lower support device 48 can be referred to as lower recesses of the lower support device 48. A guide rail piece is fixed to the corresponding rail support using a metal bracket (not shown).

It is also possible for the through-holes of the upper support device to have a larger diameter than the through-holes of the rail support. This makes it possible for the rail support to be easily displaced in the horizontal direction relative to the upper support device.

The rail support 66 is, moreover, with two self-tapping screws 74, connected to the upper support device 50 and the lower support device 48. In FIG. 4, a transport state of the pit module 14 is thus shown in which the upper support device 50 and the lower support device 48 are immovably but detachably connected to one another. The self-tapping screws 74 can be unscrewed upwards, whereby the aforementioned detachable connection between the upper support device 50 and the lower support device 48 can be released from above. The described detachable connection can also be realized with, instead of self-tapping screws, clamping sleeves, which can be knocked out or drilled out from above to release the connection.

The two buffers 52 rest, from above, on the upper support device 50 via buffer supports 76, not shown in FIG. 3. The buffer supports 76 are basically designed in the same way as the rail supports 66, so that the statements regarding the rail supports 66 apply accordingly to the buffer supports 76.

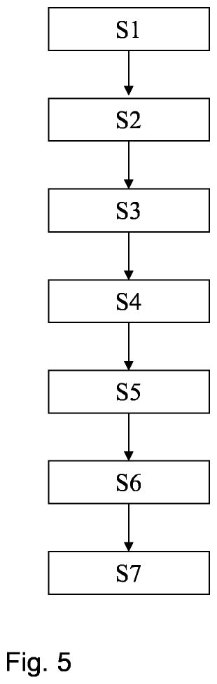

In connection with FIG. 5, a method for producing an elevator shaft, composed of shaft modules mounted one on top of the other, of an elevator system is described below. In step S1, a pit module, one or more base modules, and a top module are produced in a factory at a manufacturing site and equipped with elevator components. The various shaft modules can be manufactured at various manufacturing sites, and, for each shaft module, different manufacturing steps can be carried out at different manufacturing sites.

The pit module is produced in accordance with the pit module described in connection with FIGS. 3 and 4. An upper support device, a lower support device, guide rail pieces, and buffers are thus arranged in the pit module. The arrangement of the buffers is optional. The pit module is brought into its transport state in step S1, i.e., the upper support device and the lower support device are immovably but detachably connected to one another, as described above. In particular, as described above, the guide rail pieces and the buffers are connected to the upper support device and the lower support device.

After step SI is completed, the shaft modules are transported in step S2 to the construction site of the building receiving the elevator system, i.e., to the installation site. This is carried out, for example, by means of a truck via the highway. Steps S1 and S2 can together be referred to as providing the shaft modules.

Subsequently, in step S3, the pit module is first arranged on a shaft floor in or on the building, i.e., in particular placed on the shaft floor using a crane. After the pit module has been arranged, the base modules are placed one after the other, and the elevator shaft is then closed at the top with the top module. In the following step S4, the lower support device of the pit module is mortared in place relative to the shaft floor. For this purpose, in particular, expanding mortar is introduced into the space between the lower support device and the shaft floor.

After completion of step S4, the upper support device is aligned in step S5. To do this, the pit module is first brought from its transport state into the installed state. The connection between the upper support device and the lower support device is released, i.e., the self-tapping screws are removed, or the clamping sleeves are drilled out or knocked out. The upper support device can then be moved relative to the lower support device so that it is correctly aligned. It is also possible for the pit module to be brought into the installed state before the lower support device is mortared.

In the subsequent step S6, as described in connection with FIG. 4, the guide rail pieces and optionally the buffers together with the upper support device and the lower support device are fixed to the shaft floor by means of fasteners. The pit module is thus brought from the installed state into the operating state in which the upper support device is arranged immovably relative to the lower support device.

The following step 7 comprises all other necessary steps not further described to complete the elevator shaft.

Finally, it should be noted that terms such as “having,” “comprising,” etc., do not preclude other elements or steps, and terms such as “a” or “an” do not preclude a plurality. Furthermore, it should be noted that features or steps which have been described with reference to one of the above exemplary embodiments may also be used in the context of the claims in combination with other features or steps of other exemplary embodiments described above. Reference signs in the claims should not be considered to be limit-ing.

1. A shaft module for forming a lowermost shaft module of an elevator shaft composed of shaft modules mounted one on top of the other, comprising
a first side wall,
a second side wall opposite the first side wall,
a guide rail piece fixed at least indirectly to one of the side walls,
a lower support device and
an upper support device,
wherein
the upper support device rests on the lower support device from above,
the guide rail piece rests on the upper support device- and the lower support device from above,
the lower support device is immovably connected to a lower and of the first side wall and a lower end of the second side wall and thus extends between the lower end of the first side wall and the lower end of the second side wall.
the shaft module is configured to assume an installed state and an operating state,
in the operating state of the shaft module the upper support device is arranged immovably relative to the lower support device, and
in the installed state of the shaft module, the upper support device is arranged so as to be displaceable relative to the lower support device

2. The shaft module according to claim 1, wherein the upper support device has an upper recess and the lower support device has a corresponding lower recess, which are configured so as to overlap at least partially both in the installed state and in the operating state of the shaft module.

3. The shaft module according to claim 1, wherein, in the transport state of the shaft module, the upper support device and the lower support device are immovably but detachably connected to one another.

4. The shaft module according to claim 3, wherein the detachable connection between the upper support device and the lower support device is configured to be released from above.

5. The shaft module according to claim 3, wherein, through said detachable connection between the upper support device and the lower support device, a guide rail piece and/or a buffer is fixed at least indirectly to the upper support device,

6. A method for producing an elevator shaft composed of shaft modules mounted one on top of the other, comprising:
providing a shaft module according to claim 1,
arranging said shaft module on a shaft floor,
aligning the upper support device, and
fixing the upper support device and the lower support device to the shaft floor.

7. The method according to claim 6, further comprising mortaring the lower support device relative to the shaft floor.
